(19) United States
(12) Patent Application Publication
(10) Pub. No.: US 2026/0245191 A1
(43) Pub. Date: Aug. 20, 2026

(54) CAMERA ABNORMALITY DETERMINATION DEVICE

(71) Applicant: TOYOTA JIDOSHA KABUSHIKI KAISHA, Toyota-shi (JP)

(72) Inventor: Makoto NISHIDA, Aichi-gun (JP)

(73) Assignee: TOYOTA JIDOSHA KABUSHIKI KAISHA, Toyota-shi (JP)

(21) Appl. No.: 19/451,057

(22) Filed: Jan. 16, 2026

(30) Foreign Application Priority Data
Feb. 14, 2025 (JP) 2025-022067

(51) Int. Cl. G06T 7/00; H04N 17/00

(52) U.S. Cl. CPC G06T 7/0002; H04N 17/002; G06T 2207/10024; G06T 2207/30168

(57) ABSTRACT

The camera abnormality determination device determines an abnormality of a camera mounted on a vehicle V. The camera abnormality determination device includes an abnormality determination unit that compares a reference image of a reference camera and a determination target image of a determination target camera, and determines an abnormality of the determination target camera. The abnormality determination unit determines that an abnormality has occurred in the determination target camera in a case where color components of the reference image and color components of the determination target image deviate from each other by a color component threshold value or more.

### CROSS-REFERENCE TO RELATED APPLICATION

This application claims priority to Japanese Patent Application No. 2025-022067 filed on February 14, 2025. The disclosure of the above-identified application, including the specification, drawings, and claims, is incorporated by reference herein in its entirety.

### BACKGROUND

### 1. Technical Field

The present disclosure relates to a camera abnormality determination device that determines an abnormality of a camera mounted on a vehicle.

### 2. Description of Related Art

A plurality of cameras is mounted on a vehicle, for example, in order to detect surrounding obstacles. In such a camera, a plastic lens may be used as a camera lens. Such a plastic lens may be discolored to yellow (yellowed) with aging. In this case, yellow may be strongly expressed in a captured image of the camera, and the detection of the obstacle, visibility of the captured image (video), and the like may be affected.

Therefore, for example, Japanese Unexamined Patent Application Publication No. 2007-300547 (JP 2007-300547 A) discloses a device that determines such an abnormality of the camera. In the device, image data captured by the camera in a certain past period is stored, and in a case where a difference from the current captured image is equal to or larger than a certain value, determination is made that the camera has an abnormality.

### SUMMARY

For example, yellow becomes stronger across an entirety of the captured image of the camera because of an influence of sunset, xenon lamp illumination, or the like. In this case, as described above, in a case where the captured image captured in the past and the current captured image are compared, since the yellow of the captured image is strong because of the influence of sunset or the like, erroneous determination is made that the camera has an abnormality.

Therefore, the present disclosure describes a camera abnormality determination device that can more precisely determine an abnormality of a camera mounted on a vehicle.

A camera abnormality determination device according to an aspect of the present disclosure is

(1) "A camera abnormality determination device that determines an abnormality of a camera mounted on a vehicle,

the camera abnormality determination device including an image acquisition unit configured to acquire a captured image from each of a plurality of the cameras, and an abnormality determination unit configured to compare a reference image that is the captured image of a reference camera as a reference among the cameras and a determination target image that is the captured image of a determination target camera as an abnormality determination target among the cameras to determine an abnormality of the determination target camera, in which the abnormality determination unit is configured to determine, in a case where a color component of the reference image and a color component of the determination target image deviate from each other by a color component threshold value or more, that the determination target camera has an abnormality."

The camera abnormality determination device may be

(2) "The camera abnormality determination device according to (1) described above, in which the abnormality determination unit is configured to determine, in a case where a yellow component of the color component of the determination target image is stronger than a yellow component of the color component of the reference image, that the determination target camera has an abnormality."

The camera abnormality determination device may be

(3) "The camera abnormality determination device according to (2) described above, in which the abnormality determination unit is configured to determine, in a case where the color component of the reference image is within a white area specified in advance and the color component of the determination target image is within a yellow area specified in advance, that the determination target camera has an abnormality."

The camera abnormality determination device may be

(4) "The camera abnormality determination device according to (3) described above, further including a cumulative temperature calculation unit configured to calculate a cumulative temperature obtained by cumulating a temperature of the determination target camera for each predetermined time, in which the abnormality determination unit is configured to determine, in a case where the cumulative temperature is equal to or higher than a cumulative temperature threshold value, the color component of the reference image is within the white area, and the color component of the determination target image is within the yellow area, that the determination target camera has an abnormality."

The camera abnormality determination device may be

(5) "The camera abnormality determination device according to any one of (1) to (4) described above, in which a camera lens of the reference camera is formed of glass, and a camera lens of the determination target camera is formed of plastic."

According to an aspect of the present disclosure, it is possible to more precisely determine an abnormality of a camera mounted on a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an example of a camera abnormality determination device according to the embodiment;

FIG. 2 is a top view of a vehicle for describing a reference camera and a determination target camera mounted on the vehicle;

FIG. 3 is a diagram showing color coordinates; and

FIG. 4 is a flowchart showing a flow of an abnormality determination process of a camera in the camera abnormality determination device.

### DETAILED DESCRIPTION OF EMBODIMENTS

Hereinafter, an exemplary embodiment will be described with reference to the drawings. In each drawing, the same or corresponding elements are designated by the same reference numerals, and duplicate descriptions thereof will be omitted.

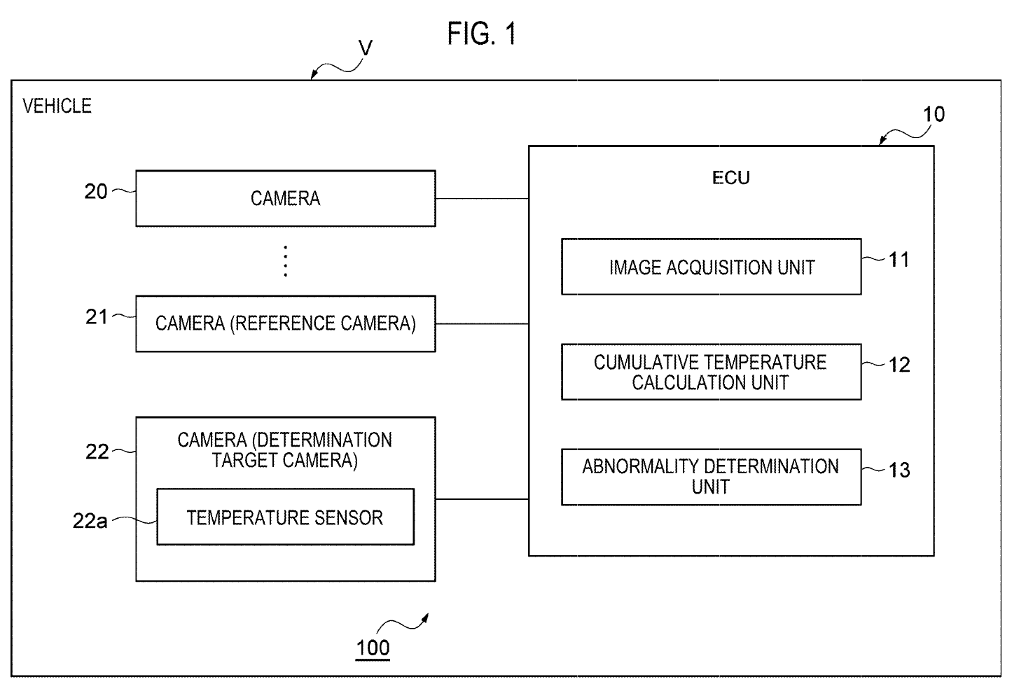

As shown in FIG. 1, a camera abnormality determination device 100 is mounted on a vehicle V. The camera abnormality determination device 100 determines an abnormality of a camera 20 mounted on the vehicle V. A plurality of cameras 20 are mounted on the vehicle V. The camera 20 includes a reference camera 21 and a determination target camera 22. The camera abnormality determination device 100 determines an abnormality of the determination target camera 22 based on the captured image of the reference camera 21 and the captured image of the determination target camera 22.

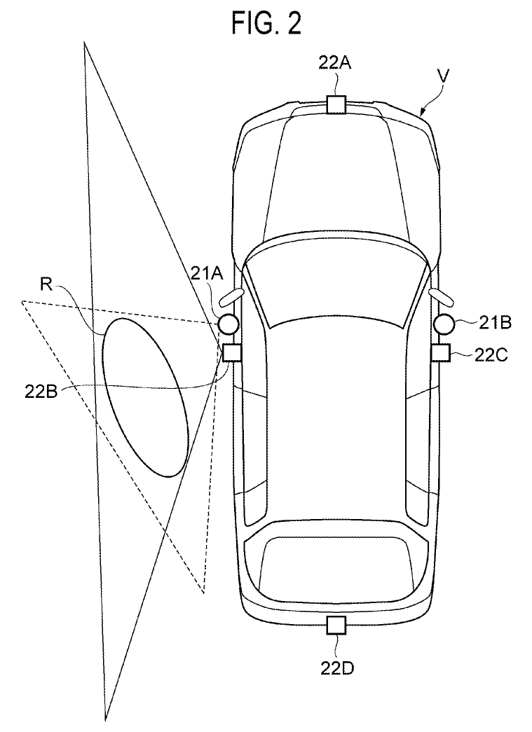

As shown in FIG. 2, the cameras 20 include a left rear camera 21A that images an area rearward of the vehicle V on the left side and a right rear camera 21B that images an area rearward of the vehicle V on the right side in order to detect an obstacle around the vehicle V, for example. In addition, the cameras 20 may include a camera that images an area ahead of the vehicle V, a camera that images an area rearward of the vehicle V, a camera that images an area ahead of the vehicle V on the left side, and a camera that images an area ahead of the vehicle V on the right side in order to detect an obstacle around the vehicle V, for example. The cameras 20 may include a camera for an electronic inner mirror that displays a video of the area rearward of the vehicle V on an electronic inner mirror or the like.

In addition, the cameras 20 may include a front camera 22A that images the area ahead of the vehicle V, a left side camera 22B that images an area on a left side of the vehicle V, a right side camera 22C that images an area on a right side of the vehicle V, and a rear camera 22D that images the area rearward of the vehicle V as cameras for a panoramic view monitor (PVM) that connects and displays a video around the vehicle V on a display unit in the vehicle. The reference camera 21 and the determination target camera 22 are selected from the cameras 20 mounted on the vehicle V.

The reference camera 21 and the determination target camera 22 have overlapping imaging ranges, each of which can image a common area. For example, in the example shown in FIG. 2, as an example, the left rear camera 21A may be used as the reference camera 21, and the left side camera 22B may be used as the determination target camera 22. Each of the left rear camera 21A and the determination target camera 22 can image a common area R. However, the camera 20 selected as the reference camera 21 and the determination target camera 22 is not limited to the left rear camera 21A and the determination target camera 22.

In addition, as the reference camera 21, a camera in which a camera lens is formed of glass is selected. As the determination target camera 22, a camera in which a camera lens is formed of plastic is selected. In a case where the camera lens is formed of glass, the glass camera lens is not yellowed. On the other hand, in a case where the camera lens is formed of plastic, the plastic camera lens is yellowed with aging. It is confirmed in advance that the captured image of the reference camera 21 including the glass camera lens is not yellowed. In addition, it is ensured that the glass camera lens of the reference camera 21 is not yellowed in a state of being mounted on the vehicle V.

Further, the determination target camera 22 is provided with a temperature sensor 22a. The temperature sensor 22a detects a temperature of the determination target camera 22 (a temperature inside the determination target camera 22). The temperature sensor 22a can detect a temperature around the camera lens provided in the determination target camera 22.

As shown in FIG. 1, the camera abnormality determination device 100 includes an electronic control unit (ECU) 10 that integrally manages the device. The ECU 10 is an electronic control unit including a central processing unit (CPU) and a storage unit. The storage unit is configured of, for example, a read-only memory (ROM), a random-access memory (RAM), and an electrically erasable programmable read-only memory (EEPROM). The ECU 10 realizes various functions by executing, for example, a program stored in the storage unit by the CPU. The ECU 10 may be configured of a plurality of electronic control units.

A plurality of cameras 20 including the reference camera 21 and the determination target camera 22 are connected to the ECU 10. Functionally, the ECU 10 includes an image acquisition unit 11, a cumulative temperature calculation unit 12, and an abnormality determination unit 13. The image acquisition unit 11 acquires a captured image from each of the cameras 20. The captured image acquired by the image acquisition unit 11 includes the captured image captured by the reference camera 21 and the captured image captured by the determination target camera 22. Hereinafter, the captured image of the reference camera 21 will be referred to as a reference image. The captured image of the determination target camera 22 will be referred to as a determination target image. The image acquisition unit 11 may acquire only the reference image of the reference camera 21 and the determination target image of the determination target camera 22 among the captured images of the cameras 20.

The cumulative temperature calculation unit 12 calculates a cumulative temperature obtained by cumulating a temperature of the determination target camera 22 for each predetermined time (for example, each hour) using a detection result of the temperature sensor 22a. The cumulative temperature may be a value obtained by adding temperatures or a value obtained by adding sensor values of the temperature sensor 22a. The cumulative temperature calculation unit 12 may calculate the cumulative temperature in a case where the determination target camera 22 is supplied with power and is in a state in which imaging is possible. Alternatively, the cumulative temperature calculation unit 12 may calculate the cumulative temperature at all times.

The abnormality determination unit 13 compares the reference image of the reference camera 21 that is a reference among the cameras 20 and the determination target image of the determination target camera 22 that is a determination target among the cameras 20, and determines an abnormality of the determination target camera 22. The abnormality determination unit 13 determines that an abnormality has occurred in the determination target camera 22 in a case where the color components of the reference image and the color components of the determination target image deviate from each other by a color component threshold value or more.

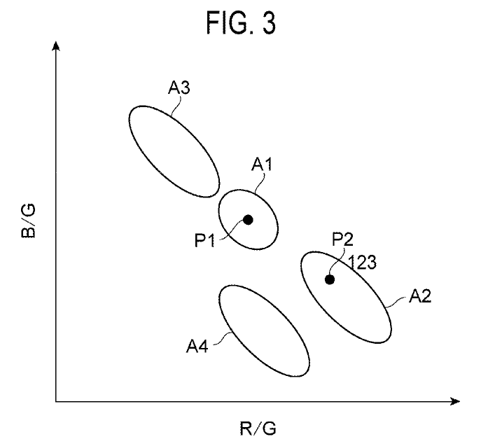

The abnormality determination unit 13 can use an average color of the reference image as the color components of the reference image. The abnormality determination unit 13 can use an average color of the determination target image as the color components of the determination target image. The color components can be represented by color coordinate values. For example, the color components (color coordinate values) can be represented by the color coordinates shown in FIG. 3. For example, in FIG. 3, the horizontal axis represents red (R) and green (G), and red is stronger as the horizontal axis goes to the right and green is stronger as the horizontal axis goes to the left. In addition, in FIG. 3, the vertical axis represents blue (B) and green (G), and blue is stronger as the vertical axis goes upward and green is stronger as the vertical axis goes downward.

The abnormality determination unit 13 may use an image of a range (image of the common area) of the reference image of the reference camera 21 that overlaps with the imaging range of the determination target camera 22 as the reference image in a case of determining the abnormality. In addition, the abnormality determination unit 13 may use an image of a range (image of the common area R) of the determination target image of the determination target camera 22 that overlaps with the imaging range of the reference camera 21 as the determination target image in a case of determining the abnormality. In this case, the reference image and the determination target image are images obtained by capturing the same area (common area R) with each other.

Therefore, in a case where the camera lens of the determination target camera 22 is not yellowed and the determination target camera 22 has no abnormality, the reference image of the reference camera 21 and the determination target image of the determination target camera 22 have the same (substantially the same) color components. For example, the color components of the reference image captured during the day and the color components of the determination target image are within a white area A1 in the color coordinates shown in FIG. 3. The white area A1 is an area within a predetermined range including white in the color coordinates. The color components of the reference image captured at the time of the setting sun and the color components of the determination target image are within a yellow area A2 in the color coordinates shown in FIG. 3. The yellow area A2 is an area within a predetermined range including yellow in the color coordinates. The white area A1 and the yellow area A2 do not overlap with each other. The white area A1 and the yellow area A2 deviate from each other by a predetermined color component threshold value or more.

For example, the color components of an image of a blue sky during the day are within a blue area A3 in the color coordinates shown in FIG. 3. The blue area A3 is an area within a predetermined range including blue in the color coordinates. For example, the color components of an image of a tree are within a green area A4 in the color coordinates shown in FIG. 3. The green area A4 is an area within a predetermined range including green in the color coordinates.

The abnormality determination unit 13 determines that an abnormality has occurred in the determination target camera 22 in a case where a yellow component of the color components of the determination target image is stronger than a yellow component of the color components of the reference image. Specifically, as shown in FIG. 3, the abnormality determination unit 13 determines that an abnormality has occurred in the determination target camera 22 in a case where the color coordinates P1 of the color components of the reference image are within the white area A1 and the color coordinates P2 of the color components of the determination target image are within the yellow area A2.

That is, in principle, both the color coordinates of the color components of the reference image that is an image captured during the day and the color coordinates of the color components of the determination target image are present in the white area A1. However, in a case where the camera lens of the determination target camera 22 is yellowed, yellow is strongly shown in the determination target image. Therefore, the abnormality determination unit 13 uses the reference image of the reference camera 21 as a reference and determines the abnormality of the determination target camera 22 based on a difference between the color components of the reference image and the color components of the determination target image.

The abnormality determination unit 13 may perform the determination by assuming that the color components of the reference image are present in the white area A1 even in a case where the color components of the reference image are within the blue area A3 in a case of performing the determination. In addition, the abnormality determination unit 13 can determine that an abnormality has occurred in the determination target camera 22 in a case where a state in which the color coordinates P1 of the color components of the reference image are within the white area A1 and the color coordinates P2 of the color components of the determination target image are within the yellow area A2 is continuously detected for a predetermined time or longer.

Here, the yellowing of the camera lens of the determination target camera 22 has a correlation with the camera temperature and the elapsed time. Therefore, the abnormality determination unit 13 can determine the abnormality of the determination target camera 22 in consideration of the cumulative temperature calculated by the cumulative temperature calculation unit 12. Specifically, the abnormality determination unit 13 determines that an abnormality has occurred in the determination target camera 22 in a case where the cumulative temperature is equal to or higher than the cumulative temperature threshold value, the color components of the reference image are within the white area A1, and the color components of the determination target image are within the yellow area A2. Here, the abnormality determination unit 13 can determine that an abnormality has occurred in the determination target camera 22 in a case where a state in which the color coordinates P1 of the color components of the reference image are within the white area A1 and the color coordinates P2 of the color components of the determination target image are within the yellow area A2 is continuously detected for a predetermined time or longer and the cumulative temperature is equal to or higher than the cumulative temperature threshold value.

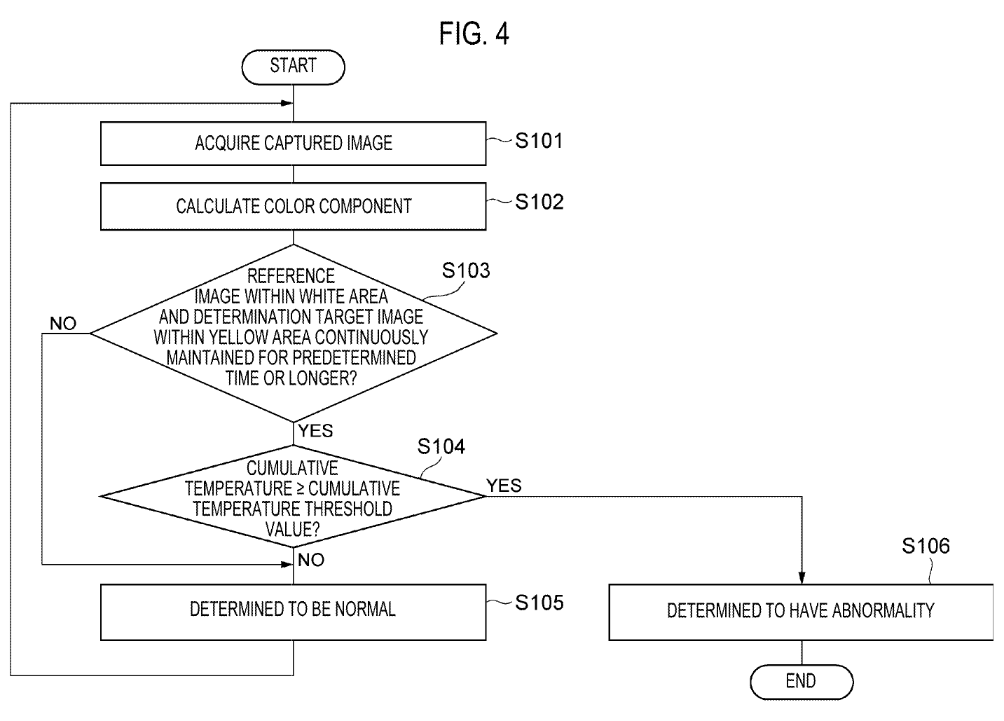

Next, a flow of an abnormality determination process of the camera in the camera abnormality determination device 100 will be described. The process shown in FIG. 4 is started with the start of imaging by the reference camera 21 and the determination target camera 22. As shown in FIG. 4, the image acquisition unit 11 acquires the reference image from the reference camera 21 and acquires the determination target image from the determination target camera 22 (S101). The abnormality determination unit 13 calculates the color components of the reference image and calculates the color components of the determination target image (S102).

The abnormality determination unit 13 determines whether a state in which the color coordinates of the color components of the reference image are within the white area A1 and the color coordinates of the color components of the determination target image are within the yellow area A2 is continuously maintained for a predetermined time or longer (S103). In a case where the state is continuously maintained for a predetermined time or longer (S103: YES), the abnormality determination unit 13 determines whether the cumulative temperature calculated by the cumulative temperature calculation unit 12 is equal to or higher than the cumulative temperature threshold value (S104).

In a case where determination is made in S103 that the state is not continuously maintained for a predetermined time or longer (S103: NO) or in a case where determination is made in S104 that the cumulative temperature is not equal to or higher than the cumulative temperature threshold value (S104: NO), the abnormality determination unit 13 determines that the determination target camera 22 is normal (S105). After the process of S105, the camera abnormality determination device 100 acquires the reference image and the determination target image captured next in S101 and repeats the above-described process.

In a case where determination is made in S104 that the cumulative temperature is equal to or higher than the cumulative temperature threshold value (S104: YES), the abnormality determination unit 13 determines that an abnormality has occurred in the determination target camera 22 (S106). In a case where determination is made that an abnormality has occurred in the determination target camera 22, the camera abnormality determination device 100 can notify the occupant or the like of the vehicle V that an abnormality has occurred in the determination target camera 22.

As described above, in a case where the abnormality of the determination target camera 22 using the plastic camera lens is determined, the camera abnormality determination device 100 uses the reference image of the reference camera 21 using the glass camera lens as a reference. The abnormality determination unit 13 of the camera abnormality determination device 100 compares the reference image of the reference camera 21 and the determination target image of the determination target camera 22. The abnormality determination unit 13 determines that an abnormality has occurred in the determination target camera 22 in a case where the color components of the reference image and the color components of the determination target image deviate from each other by a color component threshold value or more. As a result, the camera abnormality determination device 100 can more precisely determine the abnormality of the determination target camera 22 by reducing the influence of sunset or the like.

The abnormality determination unit 13 determines that an abnormality has occurred in the determination target camera 22 in a case where a yellow component of the color components of the determination target image is stronger than a yellow component of the color components of the reference image. In addition, the abnormality determination unit 13 determines that an abnormality has occurred in the determination target camera 22 in a case where the color components of the reference image are within the white area A1 and the color components of the determination target image are within the yellow area A2. As a result, the camera abnormality determination device 100 can more precisely determine that the yellowing has occurred in the camera lens (plastic camera lens) of the determination target camera 22.

The abnormality determination unit 13 further considers the cumulative temperature of the determination target camera 22 to determine the abnormality of the determination target camera 22. As a result, the camera abnormality determination device 100 can more precisely determine the abnormality of the determination target camera 22 in consideration of the correlation between the yellowing of the camera lens of the determination target camera 22 and the temperature and the elapsed time of the determination target camera 22.

Although the embodiment of the present disclosure has been described above, the present disclosure is not limited to the embodiment. For example, the abnormality determination unit 13 may change the cumulative temperature threshold value to be compared with the cumulative temperature of the determination target camera 22 according to the state of the determination target camera 22. For example, in a case where the rate of change in temperature of the determination target camera 22 is large (in a case where the change is large), the abnormality determination unit 13 may set the cumulative temperature threshold value to be smaller than in a case where the rate of change in temperature is small. That is, it may be easily determined to be an abnormality.

What is claimed is:

1. A camera abnormality determination device that determines an abnormality of a camera mounted on a vehicle, the camera abnormality determination device comprising:
an image acquisition unit configured to acquire a captured image from each of a plurality of the cameras; and
an abnormality determination unit configured to compare a reference image that is the captured image of a reference camera as a reference among the cameras and a determination target image that is the captured image of a determination target camera as an abnormality determination target among the cameras to determine an abnormality of the determination target camera,
wherein the abnormality determination unit is configured to determine, in a case where a color component of the reference image and a color component of the determination target image deviate from each other by a color component threshold value or more, that the determination target camera has an abnormality.

2. The camera abnormality determination device according to claim 1, wherein the abnormality determination unit is configured to determine, in a case where a yellow component of the color component of the determination target image is stronger than a yellow component of the color component of the reference image, that the determination target camera has an abnormality.

3. The camera abnormality determination device according to claim 2, wherein the abnormality determination unit is configured to determine, in a case where the color component of the reference image is within a white area specified in advance and the color component of the determination target image is within a yellow area specified in advance, that the determination target camera has an abnormality.

4. The camera abnormality determination device according to claim 3, further comprising a cumulative temperature calculation unit configured to calculate a cumulative temperature obtained by cumulating a temperature of the determination target camera for each predetermined time,
wherein the abnormality determination unit is configured to determine, in a case where the cumulative temperature is equal to or higher than a cumulative temperature threshold value, the color component of the reference image is within the white area, and the color component of the determination target image is within the yellow area, that the determination target camera has an abnormality.

5. The camera abnormality determination device according to claim 1, wherein:
a camera lens of the reference camera is formed of glass; and
a camera lens of the determination target camera is formed of plastic.
